(19) United States
(12) Patent Application Publication
(10) Pub. No.: US 2014/0233106 A1
(43) Pub. Date: Aug. 21, 2014

(54) OBJECT WITH REFLECTION-REDUCING COATING AND METHOD FOR THE PRODUCTION THEREOF

(71) Applicants: FRAUNHOFER-GESELLSCHAFT ZUR FOERDERUNG DER ANGEWANDTEN FORSCHUNG E.V., (US); W. BLOESCH AG, Grenchen (CH)

(72) Inventors: Michael VERGOEHL, Cremlingen (DE); Daniel RADEMACHER, Braunschweig (DE); Oliver LENK, Braunschweig (DE); Stefan BRUNS, Cremlingen (DE); Thomas NEUBERT, Wolfsburg (DE); Peter WEISS, Grenchen (CH)

(21) Appl. No.: 13/773,158

(22) Filed: Feb. 21, 2013

(51) Int. Cl. G02B 1/11

(52) U.S. Cl. CPC G02B 1/11
USPC 359/601; 427/162

(57) ABSTRACT

An object with reflection-reducing coating includes a substrate and a coating arranged on the substrate. The coating is multilayered and includes an outer layer having a refractive index n1 and at least one second sub-layer with a refractive index n2 which is adjacent to the outer layer. n2>n1+0.4, and the outer layer possesses a refractive index n1>1.50 and a layer hardness greater than 8 GPa.

### CROSS-REFERENCE TO RELATED APPLICATIONS

The present application is related to German Application No. 10 2012 002 927.6 filed Feb. 14, 2012 and European Application No. 13 154 482.7 filed Feb. 7, 2013, the disclosures of which are expressly incorporated by reference herein in their entireties.

### BACKGROUND OF THE INVENTION

1. Field of the Invention

The invention refers to an object with reflection-reducing coating, a method for the production thereof and the use of this object. The reflection-reducing coating is characterized by a high layer hardness of the outer layer, wherein the materials of the coating possess a refractive index matched to one another.

2. Discussion of Background Information

Particularly for high-quality target products, there is a demand to supply coatings that on the one hand possess anti-reflective properties and on the other hand also exhibit a mechanical protection, for example with respect to scratching. According to the prior art, layer systems of silicon dioxide and titanium dioxide or silicon dioxide and silicon nitride are used for broadband anti-reflective layers. Instead of silicon dioxide, magnesium fluoride can also be used which possesses a particularly low refractive index. However, the named materials result in layers of which the mechanical stability is limited.

DE 10 2008 054 139 A1 discloses glass objects with a scratch protection coating which has a silicon oxynitride layer for increasing the mechanical stability. DE 10 2008 054 139 A1 also discloses the use of this material for anti-reflective layer systems. However, the specified systems have a relatively low reflection reduction due to the high refractive index of silicon oxynitrides.

### SUMMARY OF EMBODIMENTS OF THE INVENTION

One aim of the invention is to disclose an object with reflection-reducing coating and a method for the production thereof, in which the coating possesses the highest possible mechanical stability and at the same time has very good reflection-reducing properties.

This aim is attained by the object with reflection-reducing coating and the method for the production thereof according to the independent claims. Further embodiments and developments are the subject matter of dependent claims and in addition result from the following description.

An object with reflection-reducing coating according to the invention has a substrate and a coating arranged on the substrate. This coating is multilayered and comprises, according to a first variant, at least one outer layer (which thus forms the boundary surface to the surrounding medium of the object, in particular air) and one additional layer, which is adjacent to the outer layer and is hereinafter referred to as “second sub-layer.” This second sub-layer is arranged on the outer layer and, in the normal case, located proximately in direct mechanical contact with the outer layer. The outer layer possesses a refractive index n₁, the second sub-layer a refractive index n₂, wherein the following holds for these refractive indices: n₂>n₁+0.4, and preferably: n₂>n₁+0.45. Furthermore, the outer layer has a refractive index n₁ of at least 1.46, but preferably of at least 1.50 and also mostly of at least 1.55, and possesses a layer hardness of at least 8 GPa. Frequently, the layer hardness is at least 10 GPa (in particular—though not exclusively—for the outer surfaces described below, which are formed from a compound of the empirical formula a SiO₂*b Al₂O₃ and for which it holds that: b>0.65*a).

According to the invention, it was recognized that an object with outstanding reflection-reducing coating that also possesses very good mechanical properties can be obtained when a material with a layer hardness >8 GPa and in particular >10 GPa can be used for the outer layer. Materials of this type are in principle known to a person skilled in the art, but they have a refractive index which does not differ enough from the refractive index of the sub-layer adjacent to the outer layer. Alternatively, materials were used according to the prior art that, although they had an adequate refractive index, had a layer hardness that was too low.

With the object which has now been described, a layer system is made available in which the outer layer (which, for example, is formed from a silicon aluminum oxide, that is, is made of or only comprises this) has a refractive index which is low enough to meet the requirements with respect to reflection reduction (if, for example, a titanium dioxide layer is present as a second sub-layer, as is often the case according to the prior art). Because of the specific properties that, for example, silicon aluminum oxides possess, the outer layer in the coatings according to the invention has a particularly high layer hardness. Accordingly, the object with reflection-reducing coating according to the invention is outstandingly suited for applications in which strong mechanical stresses occur or can occur. Here, objects which are, for example, exposed to weather, objects that must be cleaned under particularly extreme conditions or generally high-quality materials for which any scratching is undesirable should be mentioned.

That a coating is arranged on the substrate or an outer layer on the “second sub-layer” can mean here and in the following that the coating is arranged or applied proximately in direct mechanical contact with the substrate or the “second sub-layer” proximately in direct mechanical contact with the outer layer. Furthermore, the coating can however also be indirectly arranged on the substrate or the outer layer indirectly on the “second sub-layer,” that is, additional layers can be present between the second sub-layer and outer layer or between coating and substrate. For example, between the actual reflection-reducing coating and the substrate, additional layers can be present which are required for setting certain properties; in individual cases, specific functional layers may likewise also be present between outer layer and second sub-layer. A thin intermediate layer of metal can for example—as described in EP 1291331 A2—be present, in particular for reducing the reflection of the second sub-layer, and possibly a blocker layer for the protection of an intermediate layer of this type.

The layer hardness of the outer layer is measured in GPa. Here, nanoindentation is used as a measurement method according to the invention. The layer hardness is not based here on a measurement of the finished coating or of an object with the coating, but is rather determined using a pure layer that is made of the respective material. If, for example, the outer layer is produced by a sputtering method, then the sputtering method is first deposited on a reference substrate for the measurement of the layer hardness until a sufficient layer thickness is obtained in order to be able to perform the nanoindentation. The measurement can occur in accordance with the ISO standard 14577-1:2002(E).

Whenever a refractive index with a particular value is mentioned within the scope of this application, then this value always refers to the measurement of the refractive index at a wavelength of 550 nm.

According to an embodiment, the outer layer is formed from a compound of the empirical formula a SiO₂*b Al₂O₃ (therefore comprises this compound or is made thereof), wherein the oxygen atoms can also possibly be partially replaced by fluorine atoms. Expressed differently, this compound could therefore also be described using the empirical formula Si_{f}Al_{g}OₕFₖ. For the sake of better comprehensibility, however, the formulation is used that the oxygen atoms can be partially replaced by respectively two fluorine atoms. In the formula a SiO₂*b Al₂O₃, a and b can be whole numbers (in particular whole numbers from 0 to 3); furthermore, the rule applies that either a and b are not equal to zero and/or the oxygen atoms are partially replaced by respectively two fluorine atoms.

As important representatives of the compounds of this empirical formula, trimorphous aluminum silicates (which do not contain fluorine), as well as silicon aluminum fluorine oxides, silicon oxyfluorides and aluminum oxyfluorides, are to be mentioned. For the aluminum silicon oxyfluorides, the formula can also be devised that the following holds for the total amount of anions of A of the formula a SiA₂*b Al₂A₃ (or a SiO₂*b Al₂O₃ possibly with oxygen replaced by fluorine) and regarding their composition of oxygen and fluorine: total number of anions (Z) Z=2a+3b; oxygen/fluorine amount in Z: x*O+0.5y*F, wherein x+0.5y=1 (here, x and y are decimal numbers or whole numbers and x is also greater than zero). Let the compounds Al₂SiO₄F₂ and Al₂SiO₃F₄ be mentioned as examples of silicon aluminum oxyfluorides.

The outer layer can either be fully made of a compound of the empirical formula a SiO₂*b Al₂O₃ with oxygen atoms possibly partially replaced by fluorine, it can also be only essentially made of this compound or only comprise this compound. Essentially made thereof thereby means that at least 95 percent by weight, for example at least 98 percent by weight, of the outer layer is formed from this compound. The rest can, for example, be one of the common impurities; nitrogen can, however, also be intentionally incorporated into the crystal lattice, since this can lead to an increase in hardness. In the normal case, it is usually so for outer layers which are essentially made of the named compound that the crystal structure or crystal structures of the outer layer completely corresponds to the structure that is made by one or more pure compounds of the empirical formula a SiO₂*b Al₂O₃ (with fluorine atoms possibly incorporated instead of oxygen).

For outer layers which only comprise the compound of the empirical formula a SiO₂*b Al₂O₃ with oxygen atoms possibly partially replaced by fluorine and therefore have a lower content of the compound of the empirical formula a SiO₂*b Al₂O₃ (with fluorine atoms possibly present instead of oxygen), the outer layer can also have a structure in which, in addition to crystallization forms of the compound of the empirical formula a SiO₂*b Al₂O₃, regions with other crystal structures (which are based on other compounds) are also present. However, at least 75 percent by weight, for example 90 percent by weight, of the outer layer will often be based on the compound of the formula a SiO₂*b Al₂O₃, and independently hereof, at least 75 percent by weight, for example 90 percent by weight, will often possess the crystal structure of a compound of the formula a SiO₂*b Al₂O₃.

Logically, the material of the portion not accounted for by a SiO₂*b Al₂O₃ will be chosen such that, when compared to a pure layer of the corresponding material of the formula a SiO₂*b Al₂O₃, a change in the refractive index by a maximum of 0.2, in particular a maximum of 0.1, can be registered. As materials of this type, TiO₂, ZrO₂ and/or HfO₂ in an amount of up to 10 mole percent (for example, 5 mole percent and less) and, alternatively or additionally, nitrides such as AlN or Si₃N₄ in an amount of up to 10 mole percent (for example, 5 mole percent and less), for example, come into consideration. This applies correspondingly to MgF₂.

According to a preferable embodiment, the outer layer comprises a compound of the formula SiₐAl_{2b}O_{(2a+3b)} and/or a compound of the formula SiₐAl_{2b}O_{x(2a+3b)}F_{y(2a+3b)} or is made of a compound of this type. Here, the indices a, b, x and y are defined as indicated above, wherein it still holds, however, that a, b, and y are not equal to zero. Let the compound SiAl₂O₅ be named as an example for a=1, b=1; the compound Al₂(SiO₃)₃ for a=3, b=1; and the compounds SiAl₂O₅ and SiAl₂O₄F₂ for a=1, b=1, x=0.8 and y=0.4.

Using outer layers which are formed from these compounds, the requirements regarding refractive index and layer hardness of the outer layer can be realized particularly well.

According to the invention, it was observed that better nanocrystallinity (and thus higher layer hardnesses) can be achieved using higher aluminum oxide amounts. On the other hand, for materials with high amounts of amorphous phase or of completely amorphous materials (see following paragraphs), a lower amount of aluminum oxide is more advantageous with respect to the wear properties of the layer, for example with b<0.33*a (based on the empirical formula a SiO₂*b Al₂O₃).

According to an embodiment, the compound of the formula a SiO₂*b Al₂O₃ (with oxygen atoms possibly replaced by fluorine) is nanocrystalline or essentially nanocrystalline. Here, the term nanocrystalline is to be understood as meaning that the compound a SiO₂*b Al₂O₃ is not present in the amorphous phase. Essentially nanocrystalline means here that at least 50%, for example at least 90%, of the compound is not present in the amorphous phase (wherein the measurement by scanning electron microscopy described in the paragraph below is taken as a basis regarding the particle sizes which are to be labeled as nanocrystalline). Mixtures of amorphous and crystalline phase can be analyzed quantitatively by transmission electron microscopy (TEM); in particular, the amount of amorphous phase can also be determined here.

Furthermore, nanocrystalline or essentially nanocrystalline means that no particle sizes >100 nm are also present inside the outer layer, and essentially nanocrystalline that particle sizes >100 nm are present at maximally 10%, for example maximally 5%. These values are determined by X-ray diffraction. Particle sizes of more than 100 nm would lead to undesired optical scattering. Preferably, a particle size between 10 nm and 30 nm is striven for, which should then in particular be present in the outer layer at at least 90%, e.g., at least 95%. For the determination of the particle sizes, the values ascertained by scanning electron microscopy are taken as a basis here (only particle sizes of approximately 5 nm or greater are recorded here; only these are nanocrystalline within the meaning of this invention).

In summary, a compound meets the “nanocrystalline” requirement if, X-ray diffraction, no amorphous portions can be detected, and also no particle sizes >100 nm Essentially nanocrystalline means that at least 50% of the compound is present nanocrystallinely and, additionally, less than 10% of its particle sizes are >100 nm, that is, at least 80% are not amorphous and possess a particle size less than or equal to 100 nm.

Preferably, at least 90% (for example, at least 95%) of the particle sizes of the nanocrystalline portion or of the completely nanocrystalline layer are 2 to 100 nm, in particular 2 to 20 nm, and particularly preferably 5 to 10 nm (measured respectively by X-ray diffraction).

A layer with a compound of the formula a SiO₂*b Al₂O₃ that is completely nanocrystalline or essentially nanocrystalline meets, on the one hand, the requirement of particularly high hardness and, on the other hand, it also leads to little scattering loss. Amorphous portions lead namely to a lowering of the layer hardness, while particle sizes which are too coarse result in scattering processes.

A layer with a high nanocrystalline portion or a completely nanocrystalline layer can be realized particularly easily when the outer layer by pulse magnetron sputtering or by a method in which an increased temperature of more than 200° C., in particular more than 300° C., is present during the deposition of the outer layer on the substrate/deposited layer system. In order to obtain particularly good results, a temperature greater than 500° C., in particular greater than 600° C., can also be used. In order to further improve the results with respect to layer hardness and crystallinity, an electric or magnetic potential can also be applied to the substrate. Preferably, an alternating field potential is applied for glass substrates.

According to a further embodiment, the outer layer has a refractive index n₁ between 1.50 and 1.75, for example between 1.55 and 1.75, and in particular a refractive index n₁ which lies between 1.50 and 1.70, for example between 1.55 and 1.70. By utilizing outer layer refractive indices of this type, a particularly good reflection-reducing effect can be registered.

Independent of the values indicated for the refractive index n₁ in the preceding paragraph, a particularly good reflection-reducing effect can be achieved when it holds for the relation between the refractive index of the outer layer and that of the second sub-layer that the square root of the refractive index n₂ of the second sub-layer approximately corresponds to the refractive index of the outer layer. However, no optically transparent materials that have a refractive index of 2.89 are known for n₁=1.70. In this case, an anti-reflection can also be achieved through the use of multiple layers. It has proven favorable to select material similarly having a high hardness as material of the second sub-layer. ZrO₂ (n=2.20) or HfO₂ (n=2.25) are suitable materials. If necessary, the refractive index can be increased even further by mixing with a highly refractive material (TiO₂).

According to a further embodiment, the outer layer has a layer hardness which is greater than 15 GPa, preferably greater than 20 GPa. By utilizing a layer hardness of the outer layer of this type, a particularly high-quality coated object can be obtained, in particular when the refractive index of the outer layer is also less than 1.75 and, in addition, particularly lies within the range between 1.50 and 1.70, for example between 1.55 and 1.70.

Outer layers with layer hardnesses of this type are particularly achievable when the outer layer is made of a, as defined above, nanocrystalline or essentially nanocrystalline material and, independent thereof, also particularly when the material of the outer layer is made of a silicon aluminum oxide or an aluminum silicon oxyfluoride or essentially contains no other materials.

According to a further embodiment, a material is chosen for the second sub-layer of the coating which is an oxide of a metal of group IV or V of the periodic table (e.g., titanium oxide, zirconium oxide, hafnium oxide, niobium oxide and/or tantalum oxide—wherein by “oxide,” as always within the scope of this application in reference to the cation, oxides of any stoichiometry are meant); is a fluoride of one of these elements or is an oxyfluoride of one of these elements; or is tin oxide, zinc oxide, silicon nitride, aluminum nitride, cerium oxide, chromium oxide or bismuth oxide. Furthermore, the second sub-layer can also be made of a mixture of the named substances or of a mixture of one or multiples of the named substances with additional substances not mentioned. Finally, the second sub-layer can be also only essentially formed from one of the named substances, that is, in particular contain more than 80 percent by weight of one of the named substances.

According to a further embodiment, the second sub-layer will frequently have a refractive index which is at least 2.0, but is in particular at least 2.1 or even at least 2.2. Independent hereof, the second sub-layer should also have a high hardness. In order to achieve this, the second sub-layer will often be made of zirconium oxide or hafnium oxide or contain zirconium oxide and/or hafnium oxide as a main component. Titanium oxide can also possibly be present as a main component, in particular if the second sub-layer is made of titanium dioxide and of zirconium oxide and/or hafnium oxide or contains these substances. As a main component, it is to be understood here that, in terms of weight percent, this component possesses the largest share, in particular a portion greater than 50 percent by weight. A second sub-layer which contains HfO₂ and/or ZrO₂ and Nb₂O₅ or is made hereof is also conceivable. Thus, pure hafnium oxide or zirconium oxide and mixtures of these two substances with TiO₂ are to be mentioned in particular, as well as layers which contain these compounds in at least 70 percent by weight, in particular in at least 90 percent by weight. It has also proven favorable to select the zirconium such that it stabilizes in the high-temperature phase. This can be achieved by the addition of yttrium or also by tantalum in the mixing phase.

Generally, the second sub-layer can thus also be formed from a mixed material. For example, hafnium oxide can be contained (in particular in a layer of titanium oxide and/or zirconium oxide) in order to increase the hardness of the second sub-layer.

According to a further embodiment, the substrate can in particular be a vitroid, that is, a substance of the type of a glass. To be mentioned are, in particular, organic and inorganic vitroids, here in particular plastics, glasses, sapphire, but also metals are to be mentioned. In the normal case, this concerns fully transparent materials, in particular fully transparent materials of an oxidic nature or of plastic.

In order to achieve a good anti-reflective effect, the substrate, particularly if the second sub-layer has a refractive index >2.1, will possess a refractive index which is lower than that of the second sub-layer, often even considerably lower (that is, lower by at least 0.4).

According to a further embodiment, the coating comprises at least four sub-layers, in particular a layer system, in which alternatingly sub-layers of a first material with a higher refractive index and sub-layers of a second material with a lower refractive index are present. Frequently, the number of sub-layers will lie between 4 and 20, for example between 4 and 10 (wherein the range boundaries are also included). A coating with six sub-layers will often lead to a particularly advantageous compromise between economy (few layers) and good anti-reflective effect, since the total thickness of the coating logically is often not more than 400 nm, for example not more than 300 nm. Depending on the application, however, lower residual reflections are desired such that up to 20 layers can also be present; the total thickness can then be up to 2,000 nm.

The layer thickness of the individual sub-layers of the coating vary here; the layer thicknesses which are logically to be chosen for a particular number of sub-layers is known here to a person skilled in the art and can also be determined by design programs. The physical layer thickness of the outer layer is frequently between 50 and 100 nm, in particular between 70 and 120 nm. Here, a lambda/4n layer thickness is normally striven for, wherein lambda is the central wavelength of the anti-reflection (in the case of broadband anti-reflection, the value lies roughly in the middle of the spectral range) and n is the refractive index of the layer. Layer thicknesses of this type have proven useful in order to achieve a sufficient mechanical stability.

According to a second variant of the invention, the coating is at least partially present as a nanolaminate. The coating then has at least one multilayer outer layer (according to the invention, always the layer that forms a boundary surface with the surrounding medium, in particular air) and comprises a first material with a refractive index n₁ and a second material with a refractive index n₂, wherein the outer layer is present in the form of a nanolaminate with alternating layers of the first and the second material. For the refractive indices n₂ and n₁, n₂>n₁+0.4 holds and, furthermore, the layer hardness of the nanolaminate is greater than 8 GPa, frequently greater than 10 GPa, preferably greater than 15 GPa, in particular preferably greater than 20 GPa. With respect to the first and the second material, but also regarding the structure of the coated object overall, the previous specifications for the first variant apply accordingly, wherein the first material corresponds to the material of the outer layer of the first variant and the second material to the material of the second sub-layer of the first variant. In particular, a nanolaminate of this type will, for a coating, lie in a region in which an outer layer made completely of one material is otherwise arranged. The preceding explanations about the number of layers thus apply accordingly in the normal case, wherein a nanolaminate is then respectively present instead of an outer layer. According to this variant, in particular a second sub-layer as it is described in the first variant or, alternatively, a sub-layer which is formed from the material with the refractive index n₁ follows on the nanolaminate outer layer.

Here, a layer stack made of multiple thin sub-layers which are connected to one another is to be designated by the term nanolaminate. The number of layers is thereby oriented towards the thickness of the homogenous layer that is to be replaced; in particular, a nanolaminate layer has a thickness of approximately 1 to 8 nm, preferably 2-4 nm A homogenous layer with a thickness of 100 nm can then therefore be replaced by a nanolaminate multilayer with 20 to 100 individual layers. The refractive indices and the thicknesses of the layers of the nanolaminate layer are thereby chosen such that optically (e.g., within the reflection spectrum) no difference from the homogenous mixed layer can be observed. Here, alternating layers of the first and the second material are then present in the normal case.

By utilizing a nanolaminate structure of this type, the properties of the outer layer and of the highly refractive second sub-layer can be combined in an advantageous manner. Because of the nanolaminate effect, the mechanical hardness is once again increased at a constant refractive index; this is advantageous for the anti-reflective coating according to the invention.

The aim of the present invention is also directed to a method for producing an object with reflection-reducing coating, as the object was described above. Here, an at least two-layer coating is deposited on a substrate, wherein the second (more highly refractive) sub-layer with a refractive index n₂ is deposited first and the outer layer with a refractive index n₁, which is lower than that of the second sub-layer, is then deposited (or a nanolaminate as described above). Here, the deposition occurs by physical gas-phase deposition or chemical gas-phase deposition. Vapor coating, sputtering, in particular magnetron sputtering, and gas-phase deposition by ion beams (ion beam sputtering), as well as the plasma-assisted or also hot wire CVD in the field of chemical gas-phase deposition, have proven themselves particularly suitable deposition methods. Dip coatings (sol-gel method) are also conceivable. Regarding the specific method steps that are to be carried out, the standard reference works known to a person skilled in the art can also be referenced.

The deposition of the coating or of the sub-layer coating (also of a nanolaminate) can occur particularly easily by sputtering. Because of the good upscalability and the possibility of depositing very hard layers, reactive magnetron sputtering is to be named in particular.

In the sputtering method, a geometry can preferably be used in which a spatial separation of reactive gas and coating zone is achieved. The process stability is thus improved and, also, particularly good mixed layers can be produced. In plasma processes, the layer properties can likewise be influenced and optimized by the process, wherein for plasma-assisted sputtering processes of this type, the hardness of a layer can then even exceed the value of the bulk material. Here, the following process parameters are to be optimized in particular: output, pressure, magnetic field of the target, distance between substrate and target. By methods, in particular sputtering methods, in which an electric potential is applied to the substrate, ions can be drawn to the substrate and, in combination with temperature, crystalline phases can already be produced during layer growth. Methods in which a higher ionization can be registered, for example in pulsed plasma or HIPIMS processes, can be scaled up even more easily; these methods also lead to crystalline phases which are already formed during layer growth.

According to an embodiment, the method is carried out such that a layer containing fluorine can be produced, in particular a layer which is formed from a compound of the empirical formula a SiO₂*b Al₂O₃, in which the oxygen atoms are partially replaced by fluorine atoms. The gas-phase deposition then occurs with the use of a target containing fluorine and/or a process gas containing fluorine. Because pure fluorine is, in the normal case, problematic as a process gas due to its very strong reactivity, the targets or process gases in the form of fluorine compounds are used. Here, both organic and also inorganic materials are to be mentioned. In particular, fluorinated hydrocarbons or perfluorinated carbon compounds, for example CF₄, come into consideration as organic materials; metal or half-metal fluorides are to be mentioned in particular as inorganic materials, for example, aluminum fluoride or possibly also silicon fluoride. The latter fluorides have the advantage that, as a cation, they contain the same metals that are also contained in the (outer) layer which is to be deposited. For the organic fluorides, such fluorides are to be chosen for which no or only very little carbon is incorporated into the layer during the sputtering process. In particular, at any rate, an amount of carbon so small that the transparency of the coating is not impaired or not essentially impaired.

The coating described above is particularly suited to the production or coating of high-quality objects. In particular, it can be used for all flat glass products, for example, photovoltaic and solar thermal systems, motor vehicles, sensor covers, display/display glasses, glasses for clocks, architectural glass. In the clock industry, glasses for ship clocks and special clocks are to be mentioned in particular, in the field of protective covers, such glasses for touch displays. In the field of glasses, panes or windshields of motor vehicles, window panes on buildings, high-quality beverage glasses, jewelry stones and the like are also to be mentioned. The coatings with outer layers which contain a material that has the empirical formula a SiO₂*b Al₂O₃ (with possibly replaced oxygen atoms) are furthermore also outstandingly suited for objects which must possess a particular hydrothermal resistance, as is for example the case in medical engineering, or for objects which are used in a warm and damp environment. These coatings also, independently hereof, often exhibit a water-repellant and oil-repellant function, which is likewise required for many high-quality objects.

The object with coating or the method for the production thereof described above meets, with respect to the outer layer, the requirements both in terms of reflection-reduction and mechanical resilience. If the oxidic portion of the outer layer is partially replaced by fluorine, then a fine-tuning instrument also exists to vary the refractive index of the outer layer over a wide range without significantly influencing the layer hardness as a result. With fluorine, an element is thereby available which, in contrast to other materials/elements that reduce the refractive index, is non-toxic. Finally, it is also possible to precisely set the water repellency, oil repellency and surface feel for a specific application using the fluoridic portions.

Aspects of embodiments of the present invention are directed to an object with a reflection-reducing coating, comprising a substrate and a coating arranged on the substrate. The coating is multilayered and comprises an outer layer having a refractive index n1 and at least one second sub-layer with a refractive index n2 which is adjacent to the outer layer, wherein n2>n1+0.4. The outer layer possesses a refractive index n1>1.50 and a layer hardness greater than 8 GPa.

In further embodiments, the outer layer comprises a compound of an empirical formula a SiO₂*b Al₂O₃, in which the oxygen atoms at least one of are partially replaceable and partially replaced by respectively two fluorine atoms, or is made thereof, and a and b are whole numbers that are not equal to 0.

In additional embodiments, the outer layer comprises at least one of a compound of the formula SiₐAl_{2b}O(_{2a+3b}) and a compound of the formula SiₐAl_{2b}O_{x(2a+3b)}F_{y(2a+3b)}.

In yet further embodiments, with respect to the formula a SiO₂*b Al₂O₃, when b>0.65*a, the layer hardness is greater than 10 GPa, and when b<0.65*a, the layer hardness is greater than 8 GPa.

In embodiments, the compound of the formula a SiO*b Al₂O₃ is nanocrystalline.

In further embodiments, the outer layer comprises a refractive index n₁<1.75.

In additional embodiments, 1.50<n₁<1.7.

In yet further embodiments, the outer layer comprises a layer hardness >15 GPa.

In embodiments, the outer layer comprises a layer hardness >20 GPa.

In further embodiments, the at least one second sub-layer comprises a material selected from at least one oxide of a metal of group IV or V, one fluoride of a metal of group IV or V, one oxyfluoride of a metal of group IV or V, from aluminum nitride, SnO₂, ZnO, Si₃N₄, CeO₂, Bi₂O₃ and from mixtures of the named substances among one another or with other substances, or wherein the at least one second sub-layer is made of the material.

In additional embodiments, the coating comprises at least four sub-layers structured and arranged such that sub-layers of one material with a higher refractive index alternate with sub-layers of another material with a lower refractive index.

In yet further embodiments, the at least four sub-layers comprises four to twenty sub-layers.

In embodiments, the at least four sub-layers comprises six sub-layers.

Aspects of embodiments of the present invention are directed to an object with reflection-reducing coating, comprising: a substrate; and a coating arranged on the substrate.

The coating comprises at least one multilayer outer layer comprising a first material with a refractive index n₁ and a second material with a refractive index n₂, wherein the multilayer outer layer comprises a nanolaminate of the first and the second materials, wherein n₂>n₁+0.4. The multilayer outer layer possesses a refractive index n₁>1.46, and a layer hardness of greater than 8 GPa.

In additional embodiments, the multilayer outer layer possesses a refractive index n₁>1.50.

Aspects of embodiments of the present invention are directed to a method for producing an object with the reflection-reducing. The method comprises depositing the coating, which is an at least two-layer coating, on a substrate, wherein the at least one second sub-layer with the refractive index n₂, and subsequently the outer layer with the refractive index n₁<n₂ are deposited. The deposition occurs by one of physical gas-phase deposition and chemical gas-phase deposition.

In embodiments, the physical gas-phase deposition comprises one of vapor deposition, sputtering, and by ion beams, and the chemical gas-phase deposition occurs in a plasma-assisted manner

In further embodiments, the sputtering comprises magnetron sputtering.

In additional embodiments, the gas-phase deposition occurs at least one of using a target containing fluorine and a process gas containing fluorine.

Aspects of embodiments of the present invention are directed to a method of using of the object for one of photovoltaic systems, flat glass, lenses for cameras, for medical engineering devices, optical measuring devices with transparent coverings, displays, and in the clock industry.

### BRIEF DESCRIPTION OF THE DRAWINGS

Other advantages and advantageous embodiments and developments of the invention can be derived below—without restriction of the generality—from the figures and examples. Here, the following are shown:

FIG. 1 shows a reflection-reducing coating with four sub-layers;

FIG. 2 shows a reflection-reducing coating with four sub-layers, in which the outermost layer is embodied as a nanolaminate;

FIGS. 3a through 3f show the reflectivity as a function of the wavelength for different embodiments;

FIGS. 4a through c show the refractive indices, hardnesses and molar compositions, achieved under different deposition conditions, of different materials of the outer layer according to a first deposition method;

FIGS. 5a and b show the refractive indices and hardnesses, achieved under different deposition conditions, of different materials of the outer layer according to a second deposition method;

FIGS. 6a and 6b show the reflectivity of a further embodiment as a function of the wavelength (a: calculated; b: experimentally determined); and

FIG. 7 shows a sputtering arrangement.

### DETAILED DESCRIPTION OF EMBODIMENTS OF THE INVENTION

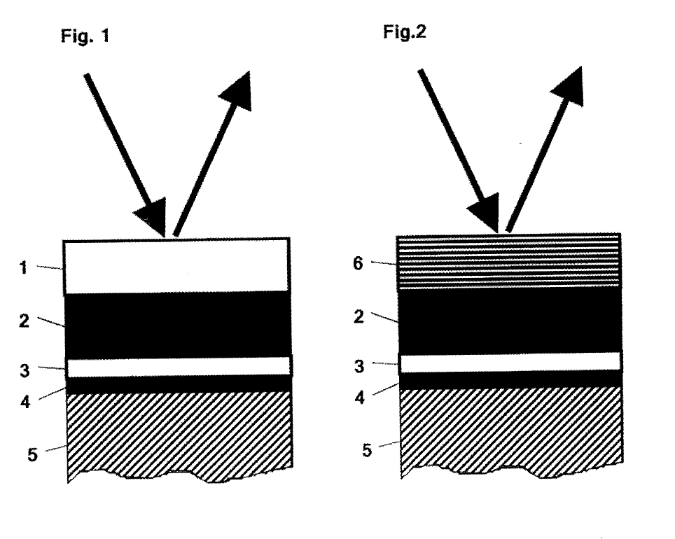

FIG. 1 shows an object according to the invention in which the coating is embodied with four sub-layers. The outer layer (1) is here made, for example, of SiAl₂O₄F₂ with a layer thickness of 85 nm. The second sub-layer (2) is a mixed layer of 20 percent by weight titanium dioxide and 80 percent by weight hafnium oxide with a layer thickness of 110 nm; the third sub-layer (3) is formed from the same material as the outer layer (1) and 40 nm thick; the fourth sub-layer (4) is formed from the same material as layer (2) and arranged directly on the substrate (5) of glass.

FIG. 2 shows a layer system which corresponds to that of FIG. 1, here however the outer layer (1) is replaced by a nanolaminate (6) which is formed from the named materials. The layer thicknesses correspond to those in FIG. 1.

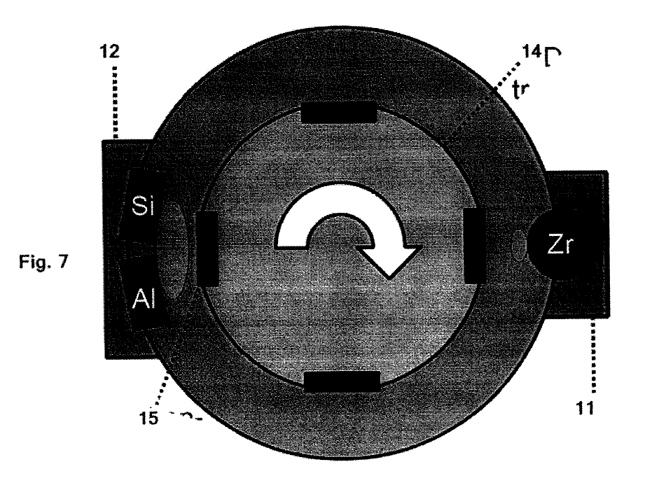

FIG. 7 shows a sputtering arrangement as it can be used according to the invention. Here, layers of aluminum silicon oxide or zirconium dioxide are deposited on a heated sample holder (15) in a rotating rotary drum (14) by a single magnetron (11) and a double magnetron (12).

### EXAMPLE 1

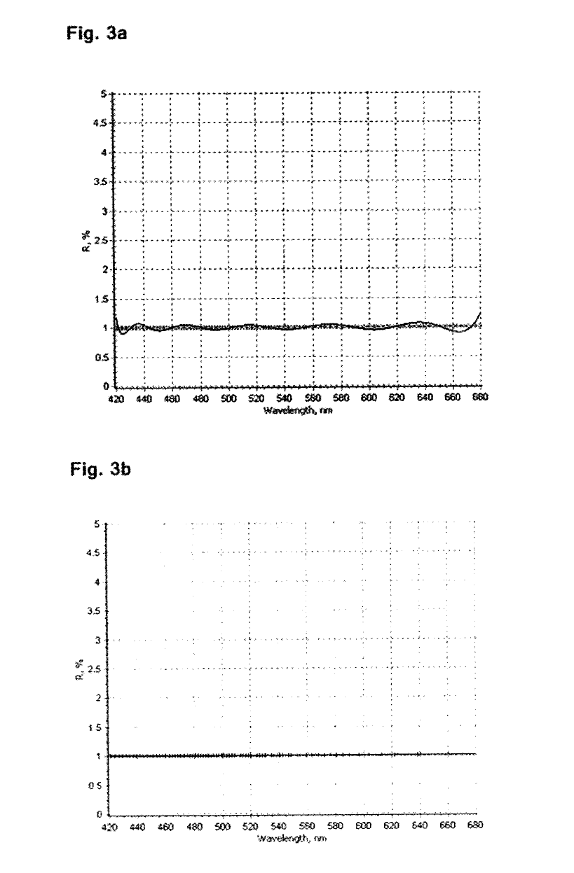

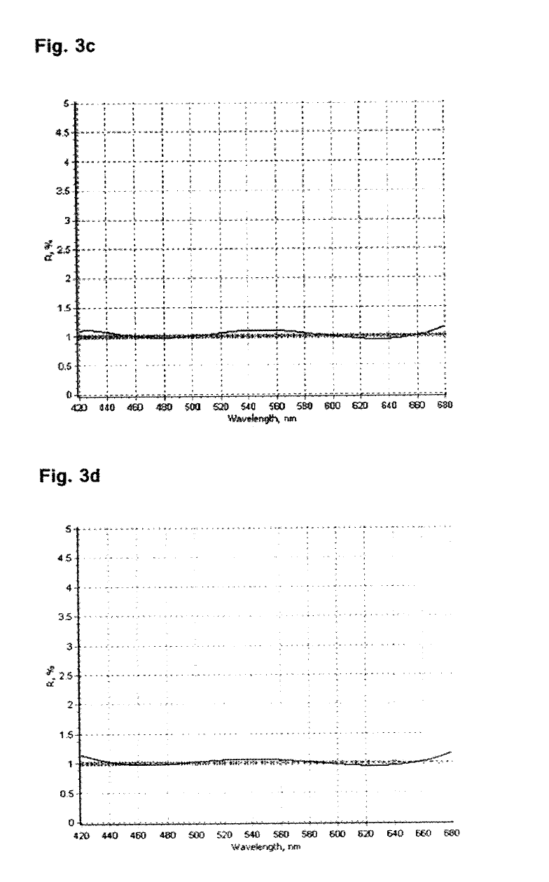

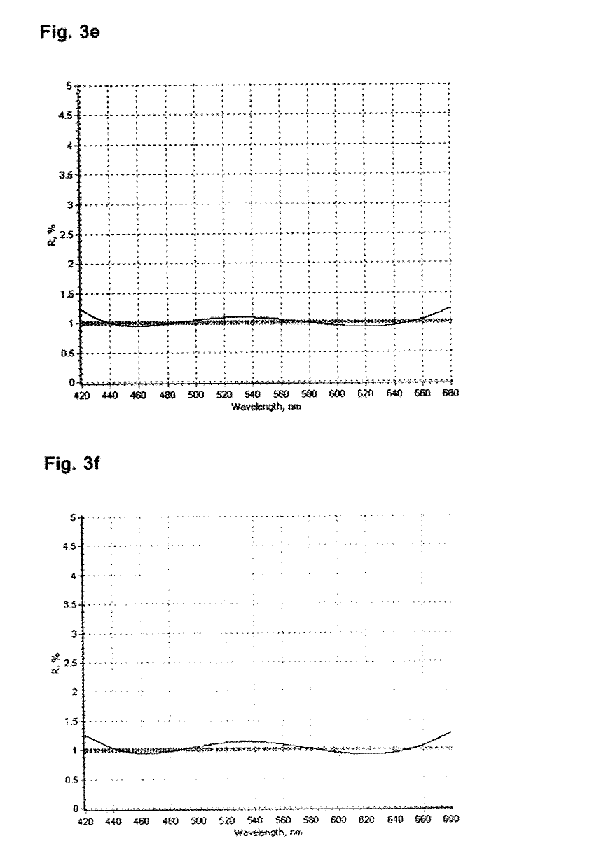

FIG. 3a shows the reflectivity as a function of the wavelength for an anti-reflective coating on a highly refractive material (sapphire) with a refractive index of 1.7 as a substrate. For the coating, 13 layers were used. The uneven layers denote a sputtered Al₂O₃ with 10 percent by weight SiO₂ with a refractive index of 1.69 (550 nm); the even layers are made of a ZrO₂ with 10 percent by weight TiO₂. For the deposition of the layers, a magnetron sputtering method was used, wherein for the layer deposition of the low refractive AlSiOₓ layer a double magnetron was used which is supplied with an alternating voltage in the medium frequency range (40 kHz). By adjusting various outputs of the two targets, the mixture can be adjusted very easily. In the example, the output of the Si target was 10% of the output of the aluminum target. Alternatively, a corresponding Al—Si mixed target can also be used. For the highly refractive material, a double magnetron with one zirconium target and one titanium target was likewise used. The output of the titanium target was 10% of the output of the zirconium target. Alternatively, the sputtering targets of the double magnetron can also be made from a metallic or ceramic mixed target.

In the following table, layer thicknesses and materials are listed, beginning with the layer with the number 01 which is arranged on the substrate:

| # | Physical Thickness [nm] | Material |
|---|---|---|
| 01 | 164.3 | Al₂O₃/SiO₂ |
| 02 | 10.7 | ZrO₂/TiO₂ |
| 03 | 56.8 | Al₂O₃/SiO₂ |
| 04 | 16.6 | ZrO₂/TiO₂ |
| 05 | 206.7 | Al₂O₃/SiO₂ |
| 06 | 13.7 | ZrO₂/TiO₂ |
| 07 | 206.1 | Al₂O₃/SiO₂ |
| 08 | 17.3 | ZrO₂/TiO₂ |
| 09 | 198.5 | Al₂O₃/SiO₂ |
| 10 | 22.5 | ZrO₂/TiO₂ |
| 11 | 170.3 | Al₂O₃/SiO₂ |
| 12 | 74.0 | ZrO₂/TiO₂ |
| 13 | 69.6 | Al₂O₃/SiO₂ |

### EXAMPLE 2

According to a further exemplary embodiment, an Al₂O₃—SiO₂ layer with a 20 percent by weight SiO₂ content and with a refractive index of 1.58 was worked with on sapphire as a substrate. As a highly refractive material, a ZrO₂ material was used, into which 10 percent by weight TiO₂ was mixed in order to slightly increase the refractive index. The ZrO₂ can be manufactured to be very hard and is therefore also scratch-resistant. A hard second sub-layer helps to improve the resistance also of the outer layer. FIG. 3b shows the reflectivity as a function of the wavelength.

In the following table, layer thicknesses and materials are listed, beginning with the layer with the number 01 which is arranged on the substrate:

| # | Physical Thickness [nm] | Material |
|---|---|---|
| 01 | 19 | Al₂O₃/SiO₂ |
| 02 | 7.2 | ZrO₂/TiO₂ |
| 03 | 58.0 | Al₂O₃/SiO₂ |
| 04 | 5.0 | ZrO₂/TiO₂ |
| 05 | 122.0 | Al₂O₃/SiO₂ |
| 06 | 11.5 | ZrO₂/TiO₂ |
| 07 | 41.4 | Al₂O₃/SiO₂ |
| 08 | 43.5 | ZrO₂/TiO₂ |
| 09 | 5.7 | Al₂O₃/SiO₂ |
| 10 | 71.0 | ZrO₂/TiO₂ |
| 11 | 84.5 | Al₂O₃/SiO₂ |

Oftentimes, it is impractical to deposit very thin layers (thickness <10 nm). Therefore, these layers can be omitted, and the design is—somewhat at the cost of residual reflection—simplified. FIG. 3c shows the reflectivity as a function of the wavelength for a layer system that only has 7 layers instead of 11.

In the following table, layer thicknesses and materials are listed for the system with a reduced number of layers, beginning with the layer with the number 01 which is arranged on the substrate:

| # | Physical Thickness [nm] | Material |
|---|---|---|
| 01 | 25.5 | Al₂O₃/SiO₂ |
| 02 | 5.5 | ZrO₂/TiO₂ |
| 03 | 177 | Al₂O₃/SiO₂ |
| 04 | 13.9 | ZrO₂/TiO₂ |
| 05 | 24.3 | Al₂O₃/SiO₂ |
| 06 | 107.4 | ZrO₂/TiO₂ |
| 07 | 78 | Al₂O₃/SiO₂ |

### EXAMPLE 3

Instead of a sapphire substrate as in Example 2, a low-refracting glass substrate (n=1.52) was used here. All other materials are identical. FIG. 3d shows the reflectivity as a function of the wavelength.

In the following table, layer thicknesses and materials are listed, beginning with the layer with the number 01 which is arranged on the substrate:

| # | Physical Thickness [nm] | Material |
|---|---|---|
| 01 | 82 | Al₂O₃/SiO₂ |
| 02 | 13.6 | ZrO₂/TiO₂ |
| 03 | 27.4 | Al₂O₃/SiO₂ |
| 04 | 109.8 | ZrO₂/TiO₂ |
| 05 | 76.2 | Al₂O₃/SiO₂ |

### EXAMPLE 4

Instead of ZrO₂—TiO₂ as material for the second sub-layer as in Example 3, pure ZrO₂ was used. All other materials are identical. All other materials are identical. FIG. 3e shows the reflectivity as a function of the wavelength.

In the following table, layer thicknesses and materials are listed, beginning with the layer with the number 01 which is arranged on the substrate:

| # | Physical Thickness [nm] | Material |
|---|---|---|
| 01 | 81 | Al₂O₃/SiO₂ |
| 02 | 14.2 | ZrO₂ |
| 03 | 25 | Al₂O₃/SiO₂ |
| 04 | 106 | ZrO₂ |
| 05 | 76 | Al₂O₃/SiO₂ |

### EXAMPLE 5

Instead of a sapphire substrate as in Example 4, a low-refracting glass substrate (n=1.52) was used here. All other materials are identical. All other materials are identical. FIG. 3f shows the reflectivity as a function of the wavelength.

In the following table, layer thicknesses and materials are listed, beginning with the layer with the number 01 which is arranged on the substrate:

| # | Physical Thickness [nm] | Material |
|---|---|---|
| 01 | 32 | Al₂O₃/SiO₂ |
| 02 | 22 | ZrO₂ |
| 03 | 112 | Al₂O₃/SiO₂ |
| 04 | 106 | ZrO₂ |
| 05 | 76.5 | Al₂O₃/SiO₂ |

### EXAMPLE 6

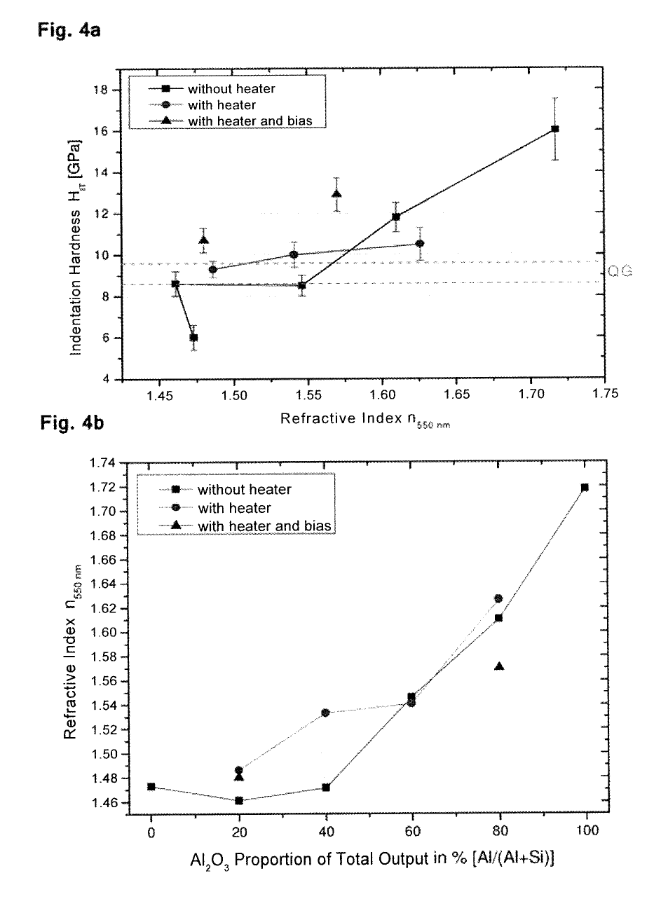

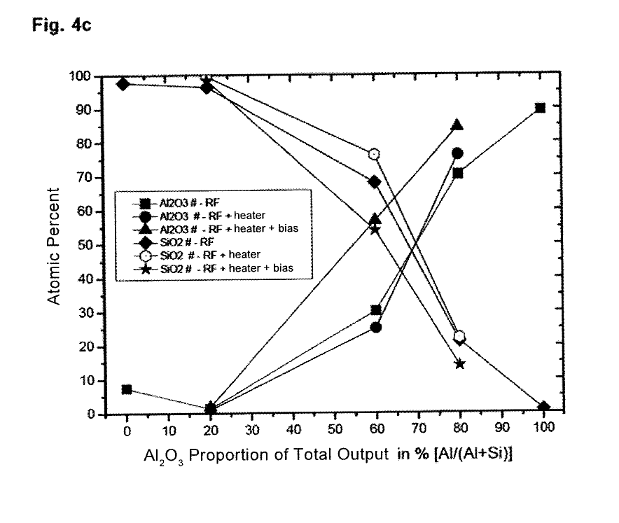

FIG. 4a shows for different materials of the outer layer the refractive indices and layer hardnesses achieved under differing deposition conditions. It is shown that, in comparison to a conventional sputtering method (squares), it is possible to both reduce the refractive index and also increase the hardness when the substrate is also heated during sputtering (circles). This can be even further improved if, in addition to the heating of the substrate, a potential is also applied to the substrate (triangles). For heating, a heater temperature of 500° C., measured on the substrate, was set. An RF sputtering process was used (radio frequency: 13.56 MHz), wherein sputtering occurred respectively from two targets (one aluminum target and one silicon target) at the same time. As a substrate, a quartz substrate was used.

The refractive indices specified in FIG. 4a are obtained by setting a different output of the two targets. For this purpose, FIG. 4b shows which Al₂O₃ portion of the total output (in %) is used under the different deposition conditions to obtain which refractive index. Finally, FIG. 4c shows the molar amount of Al₂O₃ and SiO₂ in the obtained layers for a given Al₂O₃ portion of the total output (in %) according to FIG. 4b under the different deposition conditions (conventional method: Al₂O₃—squares, SiO₂—diamonds/method with substrate heating: Al₂O₃—circles, SiO₂—hexagons/method with substrate heating and potential: Al₂O₃—triangles, SiO₂—stars).

### EXAMPLE 7

For determining the layer hardness, Al₂O₃/SiO₂ layers were deposited reactively in the transition mode on a sapphire substrate from an aluminum target and a silicon target with a thickness of 300-400 nm. The mixture ratio was thereby set in a medium frequency process (5-30 kHz) by selection of the ratio of the pulse durations of the respective target. Furthermore, mixtures were produced using a medium frequency sine generator (40 kHz). One sample set was located on a holder with floating potential, one on a holder which was heated (substrate holder approximately 300-450° C.) and provided with bias (approximately twice the frequency compared to the sputtering process), as well as a third sample set on a holder provided only with bias.

By selection of the mixture ratio, hardness and refractive index can be set. However, with the pulsed method used here, the layer hardnesses of the RF sputtering process described in the preceding example are not fully achieved.

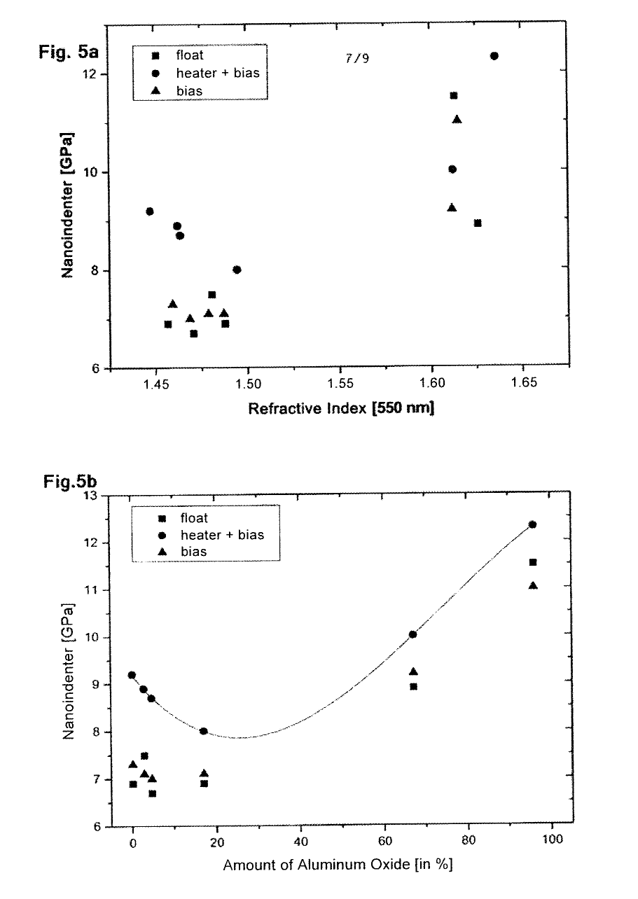

The refractive indices specified in FIG. 5a are obtained by setting a different output of the two targets. For this purpose, FIG. 5b shows which Al₂O₃ portion (in atomic %) is used under the different deposition conditions to obtain which refractive index. Here, again, the layers obtained using substrate heating and potential exhibit the best properties (conventional method: squares/method with potential: triangles/method with substrate heating and potential: circles).

### EXAMPLE 8

In a sputtering arrangement according to FIG. 7, a nanolaminate was deposited during slow rotation of the drum (0.3 rpm). A medium frequency sine process (40 kHz) on the double magnetron and a unipolar pulse process (50 kHz) on the single-tube magnetron were active in the reactive, oxidic mode. A layer stack of approximately 4 nm of ZrO₂ and 10 nm of SiO₂ in alternation thereby develops.

In this manner, a layer hardness for the nanolaminate could be measured by nanoindentation of 10.0±0.3 GPa at a refractive index of 1.69. The mixture ratio and therefore the refractive index can be set by selection of the output at the two sources.

### EXAMPLE 9

A 5-layer anti-reflective system was deposited using an aluminum silicon oxide mixture as a low-refractive material. The mixture was produced using the reactive process according to Example 7 with a low aluminum oxide content (approximately 5 atomic %). The design was first calculated for a range of 400-700 nm on sapphire substrate with a total thickness of 220 nm and then deposited. Here, the following layers were applied in sequence to the sapphire substrate: Sapphire/SiAlOₓ 15 nm/ZrO₂ 34 nm/SiAlOₓ 28 nm/ZrO₂ 45 nm/SiAlOₓ 98 nm. As a highly refractive material, ZrO₂ deposited in a pulsed manner (50 kHz) was used. The hardness of the overall system is 9.5±1 GPa.

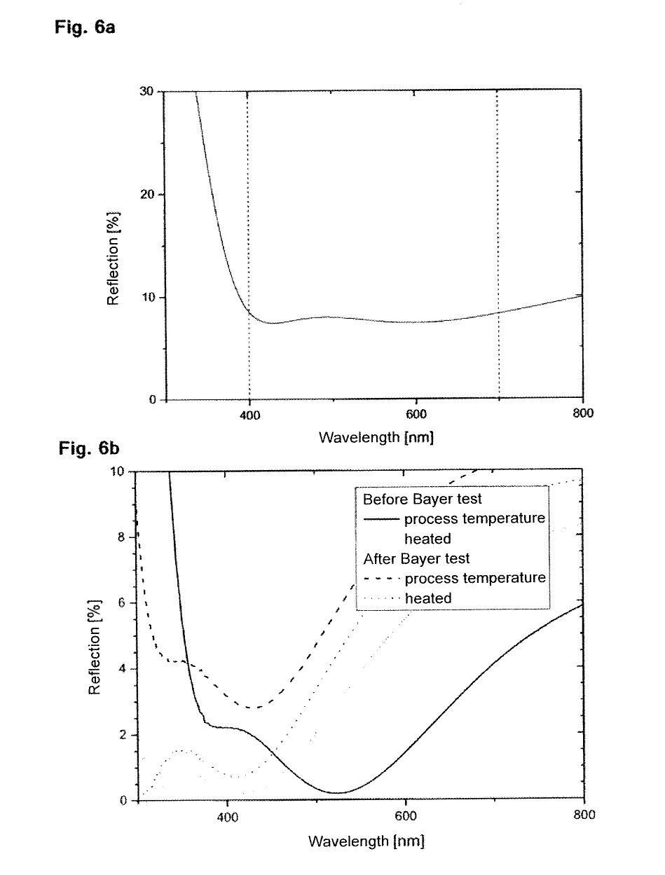

The calculated reflection curve for one-sided coating is shown in FIG. 6a. The heated system exhibits an improved resistance to abrasion in the Bayer test (the Bayer test is understood here as meaning the version described in EP 1148037 A1). While the unheated system has here a layer thickness loss of 38 nm, only 6 nm are abraded in the heated system. Also, the increase of the integrated haze after the sand trickling test (DIN 52 348—1985) is at 4.41 lower than 5.54 for the unheated sample. These results can be reinforced with the aid of the measurement of the reflection on a sapphire substrate with a roughened rear side. In FIG. 6b, the reflection is illustrated respectively before and after the Bayer test. The deviation from the calculated spectrum comes about due to a not yet corrected tooling factor between the layer thickness monitor and target substrate. It can be recognized that for the heated system (dotted lines), outstanding results can be registered even after performing the Bayer test.

1-15. (canceled)

16. An object with a reflection-reducing coating, comprising:
a substrate; and
a coating arranged on the substrate,
wherein the coating is multilayered and comprises:
an outer layer having a refractive index n1; and
at least one second sub-layer with a refractive index n2 which is adjacent to the outer layer,
wherein n2>n1+0.4, and
wherein the outer layer possesses a refractive index n1>1.50 and a layer hardness greater than 8 GPa.

17. The object according to claim 16, wherein the outer layer comprises a compound of an empirical formula a SiO₂*b Al₂O₃, in which the oxygen atoms at least one of are partially replaceable and partially replaced by respectively two fluorine atoms, or is made thereof, and
wherein a and b are whole numbers that are not equal to 0.

18. The object according to claim 16, wherein the outer layer comprises at least one of a compound of the formula SiₐAl_{2b}O(_{2a+3b}) and a compound of the formula SiₐAl_{2b}O_{x(2a+3b)}F_{y(2a+3b)}.

19. The object according to claim 17, wherein with respect to the formula a SiO₂*b Al₂O₃, when b>0.65*a, the layer hardness is greater than 10 GPa, and when b<0.65*a, the layer hardness is greater than 8 GPa.

20. The object according to claim 17, wherein the compound of the formula a SiO₂*b Al₂O₃ is nanocrystalline.

21. The object according to claim 16, wherein the outer layer comprises a refractive index n₁<1.75.

22. The object according to claim 21, wherein 1.50<n₁<1.7.

23. The object according to claim 21, wherein the outer layer comprises a layer hardness >15 GPa.

24. The object according to claim 23, wherein the outer layer comprises a layer hardness >20 GPa.

25. The object according to claim 16, wherein the at least one second sub-layer comprises a material selected from at least one oxide of a metal of group IV or V, one fluoride of a metal of group IV or V, one oxyfluoride of a metal of group IV or V, from aluminum nitride, SnO₂, ZnO, Si₃N₄, CeO₂, Bi₂O₃ and from mixtures of the named substances among one another or with other substances, or wherein the at least one second sub-layer is made of the material.

26. The object according to claim 16, wherein the coating comprises at least four sub-layers structured and arranged such that sub-layers of one material with a higher refractive index alternate with sub-layers of another material with a lower refractive index.

27. The object according to claim 26, wherein the at least four sub-layers comprises four to twenty sub-layers.

28. The object according to claim 26, wherein the at least four sub-layers comprises six sub-layers.

29. An object with reflection-reducing coating, comprising:
a substrate; and
a coating arranged on the substrate,
wherein the coating comprises at least one multilayer outer layer comprising a first material with a refractive index n₁ and a second material with a refractive index n₂,
wherein the multilayer outer layer comprises a nanolaminate of the first and the second materials, wherein n₂>n₁+0.4, and
wherein the multilayer outer layer possesses a refractive index n₁>1.46, and a layer hardness of greater than 8 GPa.

30. The object according to claim 29, wherein the multilayer outer layer possesses a refractive index n₁>1.50.

31. A method for producing an object with the reflection-reducing coating according to claim 16, comprising:
depositing the coating, which is an at least two-layer coating, on a substrate, wherein the at least one second sub-layer with the refractive index n₂, and subsequently the outer layer with the refractive index n₁<n₂ are deposited,
wherein the deposition occurs by one of physical gas-phase deposition and chemical gas-phase deposition.

32. The method of claim 31, wherein one of:
the physical gas-phase deposition comprises one of vapor deposition, sputtering, and by ion beams, and
the chemical gas-phase deposition occurs in a plasma-assisted manner.

33. The method of claim 32, wherein the sputtering comprises magnetron sputtering.

34. The method of claim 32, wherein the gas-phase deposition occurs at least one of using a target containing fluorine and a process gas containing fluorine.

35. A method of using of the object according to claim 16 for one of photovoltaic systems, flat glass, lenses for cameras, for medical engineering devices, optical measuring devices with transparent coverings, displays, and in the clock industry.
